(19) United States
(12) Patent Application Publication
(10) Pub. No.: US 2008/0195474 A1
(43) Pub. Date: Aug. 14, 2008

(54) METHOD OF PROVIDING MEDIA CONTENT FOR A PORTABLE MEDIA PLAYER

(75) Inventors: Jack LAU, Hong Kong (CN); Chi-Ying TSUI, Hong Kong (CN); Kai Kin CHAN, Hong Kong (CN); Ping KOW, Hong Kong (CN); Chor Tin MA, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: PERCEPTION DIGITAL LIMITED

(21) Appl. No.: 11/690,263

(22) Filed: Mar. 23, 2007

(30) Foreign Application Priority Data
Feb. 14, 2007 (HK) 07101763.6

(51) Int. Cl. G07G 1/14; G06F 17/30; G06F 15/16

(52) U.S. Cl. 705/14; 707/1; 707/10; 709/217

(57) ABSTRACT

A method of providing media content for a portable media player makes available in a database entertainment content and message content for downloading and storing on a portable media player. The message content is downloaded and stored on the media player with the entertainment content for playing on the media player in connection with playing of the entertainment content. The play data for entertainment content and/or message content stored on the media player is uploading to the database or another database.

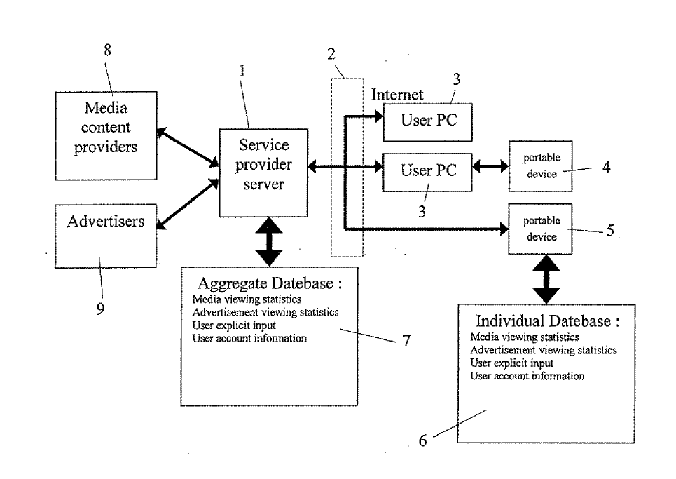

### BACKGROUND TO THE INVENTION

1. Field of the Invention

The current invention relates to portable media players. More particularly, it relates to a method of providing media content for a portable media player.

Portable media players are often referred to as MP3 players. This originates from their original use as players for MP3 encoded music. Commonly these players are now truly multimedia devices being able to store and play music, video clips and photograph or image slideshows. They are also now integrated with numerous other portable devices such as mobile phones, digital assistants and electronic dairies (e.g. PDAs), portable games devices, handheld computers and portable email handsets (e.g. the widely used Blackberry handsets) to name just a few. In this specification the terms portable media player, portable device and the like refer to any portable device capable of storing and playing media content such as music, photographs, images and video regardless of it form or primary purpose.

2. Background Information

Portable media players are a very popular and widespread medium for listening to and viewing entertainment content such as music, photographs/images and video clips. Stand alone media players are very popular and media players are incorporated into many other portable devices, for example mobile phones. Accordingly, portable media players present an excellent medium for reaching a significant percentage of the population, especially the younger and middle generations. However, delivering message and promotional content to portable media devices can be difficult as owners and users of those devices have significant control over the content which is downloaded and stored on them.

Additionally, users may desire to update or amend the contents stored on a device on a regular basis which can become a time consuming and tedious task.

Accordingly, it is an object of the present invention to provide a method of providing media content for a portable media player which overcomes or less ameliorates one or both of the above-mentioned problems.

### SUMMARY OF THE INVENTION

In a first aspect of the invention there is provided a method of providing media content for a portable media player comprising making available in a first database entertainment content and message content for downloading and storing on a portable media player, wherein the message content is downloaded and stored on the media player with the entertainment content for playing on the media player in connection with playing of the entertainment content, and uploading to the first database or another database play data for entertainment content and/or message content stored on the media player.

Preferably, the message content is one of an advertisement, a public notice or a paid announcement.

Preferably, the message content is one or more of an audio, a photo or a video message played concurrently or consecutively with the entertainment content.

Preferably, the entertainment content is a commercial entertainment video, photo or video.

Preferably, the entertainment content further comprises text message such as a RSS feed or a blog.

Preferably, the entertainment content is associated with a message content which is a survey or a competition, wherein through the survey the user provides feedback to the entertainment content providers or service providers and through the competition the user exchange for benefits, rewards or prizes.

Preferably, the message content is a paid advertisement or announcement that promotes or endorses the goods or services of a sponsor of the entertainment content.

Preferably, the play data comprises one or more of the number of times the content has been played, the total play time of the content, the last play time of the content, portable player device user information and survey or competition answers.

Preferably, the total play time is a percentage of a play time of the content.

Preferably, the user information is one or more of a content rating or user age, gender, profession, nationality, name, account name, billing information and/or shipping address.

Preferably, the uploading of the play data is via the internet.

Preferably, the method further comprises storing in the first database or the other database the play data and analysing the stored play data to determine billing information for billing a sponsor of the content.

Preferably, the method further comprises storing in the first database or the other database the play data and analysing the stored play data to determine content preferences of the portable media player user.

Preferably, the method further comprises making available new content for updating or replacing the content stored in the portable media player in accordance with the preferences of the portable media player user.

Preferably, the method further comprises storing in the first database or the other database the play data and making the stored play data available for statistical analysis.

In a second aspect of the invention there is also provided a method of providing media content for a portable media player comprising making available in a first database media content for downloading and storing on a portable media player, then when a portable media player is connected to the database downloading the content to the portable media player, recording in the media player play data for the downloaded content, then when the portable media player is next connected to the first database uploading to the first database or another database the play data recorded in the media player, analysing the play data in the first or other database and downloading to the portable media player new content based on the analysis.

Further aspects and disclosure of the invention is provided in and will become apparent from the following description.

### BRIEF DESCRIPTION OF THE DRAWINGS

Exemplary forms of the present invention will now be described by way of example only and with reference to the accompanying drawing which is a schematic overview of a system for implementing a method of providing media content for a portable media player according to the invention.

### DESCRIPTION OF THE INVENTION

Referring to the attached drawing, there is schematically depicted a system providing media content; which can be both entertainment content such as music, photographs or video clips for entertainment and enjoyment purposes and/or message content such as advertisements, paid announcement or public notices; for download to a portable media player. Connected to the internet 2 is a service provider server 1 on which there is a stored a database of the media content for downloading over the internet 2 to a users personal computers (PCs) 3 or directly to a Wireless Application Protocol (WAP) or WiFi enabled portable media player 4. Media content downloaded to a PC 3 can be transferred to a portable device 5 immediately or at a later time. In the preferred embodiment the database contains both entertainment content and message content for downloading, but this is not essential to the invention.

The entertainment content is provided by third party media content providers such as commercial music companies, film companies, photographers and the like. The message content is provided by any organisation that wants to deliver a message to an audience of portable media player users. In the preferred embodiment it is advertisers wishing to advertise goods or services, but it could also be any public, private or charitable organisation wishing to make a public announcement or other paid announcement via this medium. The service provider sells advertising to the advertisers and makes the advertisement (i.e. message content) available in its database together with the entertainment content for downloading to the portable devices 4, 5.

In the preferred embodiment it is envisaged that the message content will be downloaded and stored on the portable media device in one of the following ways. Firstly, advertisers sponsor certain entertainment content with which they want their message content downloaded and stored on a portable device. A portable device user gets the entertainment content free in exchange for accepting the associated download of message content to their device. Secondly, a portable device user may purchase entertainment content at a discount or cheaper price in exchange for accepting the download of advertisement content with the entertainment content. The service provide may bear the cost of the discount to increase download volume which in turn makes their service more attractive to advertisers, or the entertainment content may be partially sponsored by the advertisers.

The play data uploaded from the portable devices generates necessary billing information for users and message content providers (e.g. advertisers) and generates necessary payment information for the entertainment contents providers.

The server 1 database is provided with an internet 2 interface such as a web-site or WAP-enabled web site for access by the PC 3 or WAP enable device 4. The user connects to the web site in the normal way, chooses their desired content, makes payment (or not in the case of sponsored content) and downloads the content to their devices 4, 5. The service provide site may require users to register first, but this is not essential to the invention because, as will become apparent later in the description, all personal user information may be stored in the portable device allowing for the possibility of casual access to the service provides site.

Once the media content is downloaded the user of the portable device may choose to play the entertainment content as desired. When the user plays the entertainment content this also causes the message content to be played. The message content can be played concurrently or consecutively with the entertainment content. For example, if the downloaded entertainment content is music and an advertiser has chosen to promote their goods or services or make an announcement via audio means then when the user selects the entertainment contents the message content is first play and must be listen to by the user before the entertainment contents starts. Alternatively, the advertiser may choose to have photographic (image) or video message which can be played (viewed) simultaneously on the portable media device screen while the audio entertainment content is being played. In another alternative, the entertainment content may be images or video, in which case the message content can be audio that is listen to concurrently with the viewing of image or video, or the message content may be an image or video which is displayed immediately prior to display of the entertainment photo or video.

The portable device has a device database 6 in which the device stores play data associated with the downloaded media content. This play data includes, amongst other things, the number of times that the user has chosen to play the downloaded content, the total length of time that the content has been played and the last time that the content was played. The total length of time that the content has been played is preferably expressed as a percentage of the actual length of the media content. Expressing the total play time as a percentage gives an indication of whether the user plays the entire content each time or chooses to only play a portion of the content in each instance. For example, if the total length of time that the content has been played is one-hundred percent (100%) this indicates that user always listens to the entire content each time it is played. A total length of time that the content has been played of fifty percent (50%) indicates that on average the user stops playing the content half-way through. The play data records separate statistics for entertainment content and message content.

The device database 6 can also record user information such as user chosen ratings, feedback and survey answer for the media content including entertainment and message content, the user's age, gender, profession, nationality, name and identification information of the user with the service provided such as user name, password, billing information and shipping address.

The next time the user of the portable device chooses to visit the service provider website/database 1 to download content to his or her portable media device 4, 5 all or part of the play data from the portable device database 6 is uploaded to a server database 7 of the service provider. The server database 7 stores the play data to record content viewing statistics including entertainment and message viewing statistics, user specific inputs such as content ratings and, optionally, user account information. This database can serve a number of useful purposes. In the preferred embodiment it is used to provide information to advertisers on the viewing statistics of the content and advertisements they have bought with the service provider. Depending on a chosen advertising scheme it can also be used to provide advertiser billing information. For example, advertising fees to advertisers can be based on a number of downloads or on statistical information from the play data such as the number of times or length of time the advert or message has been played or viewed on the portable device.

Another use of the play data recorded in the portable device and uploaded to the service provider database 7 is to determine preferences of the portable device user for suggesting or automatically downloading new content to the device. In association with the current embodiment or as an entirely separate embodiment the service provider 1 may provide suggested and/or automatic content updates for portable device users. After a user has had content stored and played on their portable device play data from the content will be recorded in the device database 6. The user connects their portable device to the service provide database, via the PC 3 or directly via the internet 2, for downloading new content. The play data is uploaded to the service provide server 7. The play data is analysed to determine the user's content preferences and the service provider automatically suggests content to be kept on the portable device and content to be deleted, including new content to download to replace the deleted content. The user may chose to fully or partially follow the service provider's recommendations. If the user chooses an automatic update the new content is automatically downloaded to the portable device. Billing information within the play data can be used to automatically pay for new downloaded content. To facility a better automatic update experience the play data may in some embodiments include input information from the user about the percentage or amount of original content to keep or replace on the portable device during each update, or threshold information relating to user chosen ratings for the content, wherein content having certain ratings or rating above a threshold are kept and content with lower or no ratings is replaced during automatic updates.

In some embodiments of the invention a portable media player or client application on a connected PC can be programmed to automatically update content on the portable device at user defined intervals. At a schedule time the PC or portable device connects with the service provider's web site and uploads the latest play data from the device database. The service provider analyses the uploaded play data and provides new media content for automatic download to the portable device in accordance with user defined parameters and determined preferences. A user of the portable device can set such automatic updates to occur during non-use periods of the device, such as night time, so that every morning the device has new and fresh media content for the device user to listen to or view. The updates may be scheduled while the portable device is connected to a PC overnight and is simultaneously recharged from the PC USB port. It the device is WAP or WiFi enabled it can perform automatic updates wirelessly while connected to a proprietary changer overnight.

In further embodiment of the invention the message content from advertisers or other organisations is a type which requires or requests that the user provides feedback, complete a survey, or enter a competition. This can be in exchange for the user receiving benefits, rewards or prizes such as free content download or the like. Accordingly, any feedback survey or competition answers entered by the user on a portable device are stored in the device database 6 for upload to the service provider server 1 when a device is next connected. The survey results, questionnaire results or competition answers are then processed by the service provider or passed to the original advertiser or organisation for processing. It will be apparent to the skilled addressee that where the message content comprises a survey or competition then the message content is capable of being played on the portable device independently of the entertainment content. However, it is envisage that during the first playing or each playing of the entertainment content an alert or message will be conveyed to the user of the portable device indicating the availability of the survey or competition message, providing details of the inducement for completing the survey or entering the competition and possibly giving the option to run the survey or competition content immediately or at a later date.

It should be appreciated that modifications and/or alterations obvious to those skilled in the art are not considered as beyond the scope of the present invention.

What is claimed is:

1. A method of providing media content for a portable media player comprising:
making available in a first database entertainment content and message content for downloading and storing on a portable media player, wherein the message content is downloaded and stored on the media player with the entertainment content for playing on the media player in connection with playing of the entertainment content, and
uploading to the first database or another database play data for entertainment content and/or message content stored on the media player.

2. The method of claim 1 wherein the message content is one of an advertisement, a public notice or a paid announcement.

3. The method of claim 2 wherein the message content is one or more of an audio, a photo or a video message played concurrently or consecutively with the entertainment content.

4. The method of claim 1 wherein the entertainment content is a commercial entertainment video, photo, video or text message.

5. The method of claim 4 wherein the message content is a paid advertisement or announcement that promotes or endorses the goods or services of a sponsor of the entertainment content.

6. The method of claim 1 wherein the play data comprises one or more of the number of times the content has been played, the total play time of the content, the last play time of the content and portable player device user information.

7. The method of claim 6 wherein the total play time is a percentage of a play time of the content.

8. The method of claim 6 wherein the user information is one or more of a content rating or user age, gender, profession, nationality, name, account name, billing information and/or shipping address.

9. The method of claim 1 wherein the uploading of the play data is via the internet.

10. The method of claim 1 further comprising storing in the first database or the other database the play data and analysing the stored play data to determine billing information for billing a sponsor of the content.

11. The method of claim 1 further comprising storing in the first database or the other database the play data and analysing the stored play data to determine content preferences of the portable media player user.

12. The method of claim 11 further comprising making available new content for updating or replacing the content stored in the portable media player in accordance with the preferences of the portable media player user.

13. The method of claim 1 further comprising storing in the first database or the other database the play data and making the stored play data available for statistical analysis.

14. A method of providing media content for a portable media player comprising:
making available in a first database media content for downloading and storing on a portable media player,
then when a portable media player is connected to the database downloading the content to the portable media player,
recording in the media player play data for the downloaded content,
then when the portable media player is next connected to the first database uploading to the first database or another database the play data recorded in the media player, analysing the play data in the first or other database and downloading to the portable media player new content based on the analysis.

15. The method of claim 14 wherein the play data comprises one or more of the number of times the content has been played, the total play time of the content, the last play time of the content and/or portable player device user information.

16. The method of claim 15 wherein the total play time is a percentage of a play time of the content.

17. The method of claim 15 wherein the user information is one or more of a content rating or user age, gender, profession, nationality, name, account name, billing information and/or shipping address.

18. The method of claim 17 further comprising using the user information for billing the portable media player user for the downloaded content.

19. The method of claim 14 wherein the play data comprises one or more of the user feedback, survey answer and registration for competition.

20. The method of claim 15 further comprising using the play data for billing the message content providers or paying the entertainment content providers.
